(19) United States
(12) Patent Application Publication
(10) Pub. No.: US 2012/0154102 A1
(43) Pub. Date: Jun. 21, 2012

(54) ELECTRICAL FUSE STRUCTURE

(76) Inventor: Shi-Bai Chen, Hsinchu County (TW)

(21) Appl. No.: 12/969,593

(22) Filed: Dec. 16, 2010

(51) Int. Cl. H01H 85/08

(52) U.S. Cl. 337/290

(57) ABSTRACT

An electrical fuse structure includes a first metal strip having a first width W₁ and a first length L₁; a second metal strip having a second width W₂ and a second length L₂; and at least one via element having a via width W₀, the via element being electrically connecting one end of the first metal strip to one end of the second metal strip, wherein W₁<5W₀.

### BACKGROUND OF THE INVENTION

1. Field of the Invention

The present invention relates generally to the field of electrical fuses. More particularly, the present invention relates to a via-type electrical fuse structure with improved yield and reliability during fuse blowing operation.

2. Description of the Prior Art

Electrical fuses (or e-fuses) are commonly used in redundant circuits of memory or programmable fuse arrays to provide programming capabilities. Electrical fuses have taken many forms and generally comprise fuses having a fusible link extending between a pair of terminal portions. One type of the electrical fuses comprises via plug connecting a metal layer cathode and a metal layer anode. The electrically fuses may be deliberately “burnt through” by means of an electrical current flowing through the electrical fuse.

The programmable fuse arrays are used in conjunction with electronic circuits which may require adjustment to provide proper operation. Each electrical fuse in such an array provides either a logic one or a logic zero, depending on whether or not its fuse is “blown”. The electrical fuse in a programmable fuse array may be programmed one time only. In the electronic circuit arrangement, the electrical fuse is connected between electronic components, and is supplied with current by means of a field-effect transistor in order to degenerate or finally cut through the electrical fuse.

However, the prior art programmable fuse arrays have low yield and low reliability during fuse blowing operation. Therefore, there is a need in this industry to provide an improved electrical fuse structure to solve the prior art problems.

### SUMMARY OF THE INVENTION

It is one object of the invention to provide an improved electrical fuse structure in order to improve yield and reliability during fuse blowing operation.

To address these and other objects and in view of its purposes, the present invention provides an electrical fuse structure including a first metal strip having a first width W₁ and a first length L₁; a second metal strip having a second width W₂ and a second length L₂; and at least one via element having a via width W₀, the via element being electrically connecting one end of the first metal strip to one end of the second metal strip, wherein W₁<5W₀.

According to another aspect, the invention provides an electrical fuse structure including a first metal strip having a first width W₁ and a first length L₁; a second metal strip having a second width W₂ and a second length L₂; a connection pad between the first metal strip and the second metal strip; a first via element electrically connecting one end of the first metal strip to the connection pad; and a second via element electrically connecting one end of the second metal strip to the connection pad, wherein the first and second via elements have a via width W₀, and W₁<5W₀.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a layout top view illustrating a programmable electrical fuse according to one embodiment of the invention;

FIG. 2 is a cross-sectional view taken alone line I-I′ of FIG. 1;

FIG. 3 demonstrates an electrical fuse structure according to another embodiment of this invention;

FIG. 4 demonstrates an electrical fuse structure according to still another embodiment of this invention;

FIG. 5 is a perspective view of an electrical fuse structure according to still another embodiment of this invention;

FIG. 6 is a perspective view of an electrical fuse structure according to still another embodiment of this invention; and

FIG. 7 is a perspective view of an electrical fuse structure according to yet another embodiment of this invention.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following detailed description of the invention, reference is made to the accompanying drawings which form a part hereof, and in which is shown, by way of illustration, specific embodiments in which the invention may be practiced. These embodiments are described in sufficient detail to enable those skilled in the art to practice the invention. Other embodiments may be utilized and structural, logical, and electrical changes may be made without departing from the scope of the present invention. The terms wafer and substrate used herein include any structure having an exposed surface onto which a layer is deposited according to the present invention, for example, to form the integrated circuit (IC) structure.

The term substrate is understood to include semiconductor wafers. The term substrate is also used to refer to semiconductor structures during processing, and may include other layers that have been fabricated thereupon. Both wafer and substrate include doped and undoped semiconductors, epitaxial semiconductor layers supported by a base semiconductor or insulator, as well as other semiconductor structures well known to one skilled in the art. The term “horizontal” as used herein is defined as a plane parallel to the conventional major plane or surface of the semiconductor chip or die substrate, regardless of its orientation. The term “vertical” refers to a direction perpendicular to the horizontal as just defined. Terms, such as “on”, “above”, “below”, “bottom”, “top”, “side” (as in “sidewall”), “higher”, “lower”, “over”, and “under”, are defined with respect to the horizontal plane.

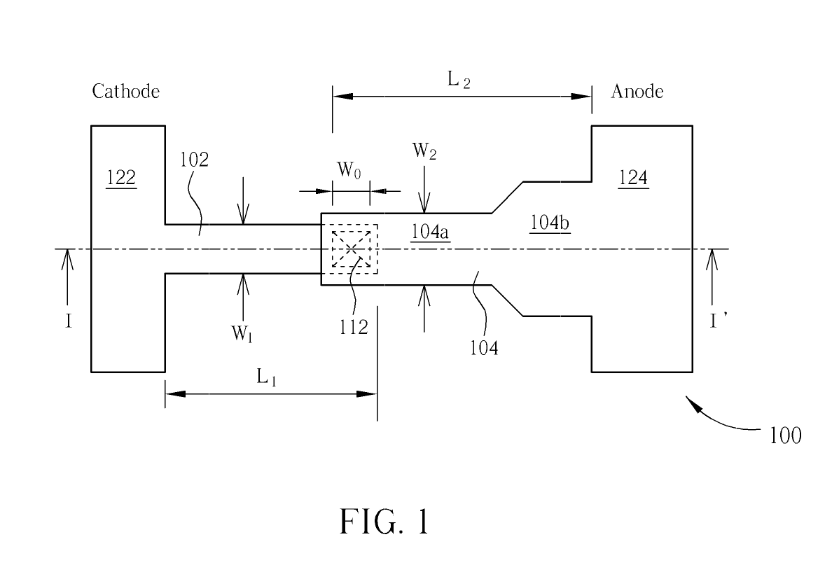

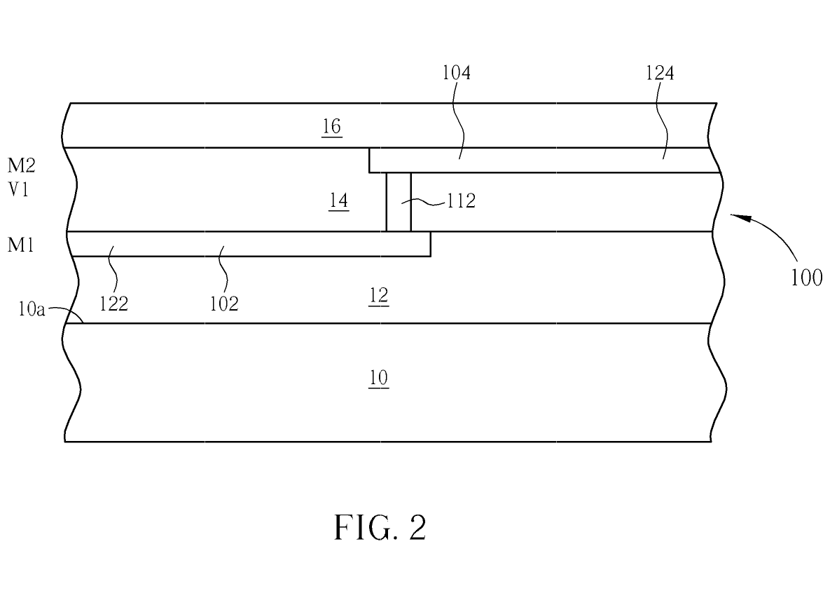

Referring to FIGS. 1 and 2, an electrical fuse structure 100 according to one embodiment of this invention is described. As shown in FIG. 1 and FIG. 2, the electrical fuse structure 100 comprises a first metal strip 102, a second metal strip 104, and a conductive via element 112 that electrically connects the first metal strip 102 with the second metal strip 104. The first metal strip 102 can be a line-shaped metal strip in this embodiment, but not limited to be. The first metal strip 102 may act as a cathode fuse link and may be fabricated in a lower level of the metal interconnection scheme, for example, in the first level metal (i.e. Metal-1 level, M1 in FIG. 2).

One end of the first metal strip 102 may be in contiguous with a cathode terminal pad 122. In this case, the first metal strip 102 joins to the cathode terminal pad 122 to form a T-shaped pattern when viewed from above. The second metal strip 104 may act as an anode fuse link and is fabricated in a higher level of the metal interconnection scheme; it means that the second metal strip 104 can be fabricated in an upper part/structure of the integrated circuit, for example, the second level metal (i.e. Metal-2 level, M2 in FIG. 2). The second metal strip 104 may include a slender line-shaped portion 104a and a tapered portion 104b.

According to this embodiment, the tapered portion 104b connects the slender line-shaped portion 104a with the anode terminal pad 124. However, it is understood that the tapered portion 104b may be spared in another embodiment of this invention.

As best seen in FIG. 2, the electrical fuse structure 100 is fabricated on a substrate such as a semiconductor substrate, silicon substrate or the like. A plurality of circuit devices (not shown) such as MOS transistors, bipolar transistors, capacitors can be formed in or on the main surface (or top) 10a of the substrate 10. A first interlayer dielectric 12 is deposited over the substrate 10. The first metal strip 102 and the cathode terminal pad 122 may be fabricated in the first interlayer dielectric 12. For example, the first metal strip 102 and the cathode terminal pad 122 of FIG. 1 may be a damascened copper layer inlaid in the first interlayer dielectric 12. In such case, a diffusion barrier layer (not shown) may be provided between the damascened copper layer and the first interlayer dielectric 12. The first interlayer dielectric 12 may include but not limited to silicon oxide, silicon nitride, silicon oxynitride, doped silicate glass, spin-on glass, low-k dielectric, ultra-low k dielectric or the like.

A second interlayer dielectric 14 is deposited over the first interlayer dielectric 12. The second interlayer dielectric 14 may be composed of a single-layered dielectric or multi-layered dielectric such as a composite dielectric including an etch stop layer interposed between two oxide layers. The second metal strip 104, the anode terminal pad 124 and the via element 112 may be fabricated in the second interlayer dielectric 14. For example, the second metal strip 104, the anode terminal pad 124 and the via element 112 may be a dual damascened copper structure inlaid in the second interlayer dielectric 14. The via element 112 may be integrally formed with the second metal strip 104 in the V1 level between M1 and M2. A third dielectric layer 16 may be formed on the second dielectric layer 14 and covers the second metal strip 104 and the anode terminal pad 124.

Referring briefly back to FIG. 1, the line-shaped first metal strip 102 has a line width W₁ and a length L₁, the slender line-shaped portion 104a of the line-shaped second metal strip 104 has a line width W₂ and the line-shaped second metal strip 104 has a length L₂, and the via element 112 has a via width W₀. According to the embodiment of the invention, W₁<5W₀ is acceptable, preferably W₁<2W₀, and more preferably is that W₁ is substantially equal to W₀. According to the embodiment of the invention, W₂<5W₀, L₁/W₁>5, and L₂/W₂>5.

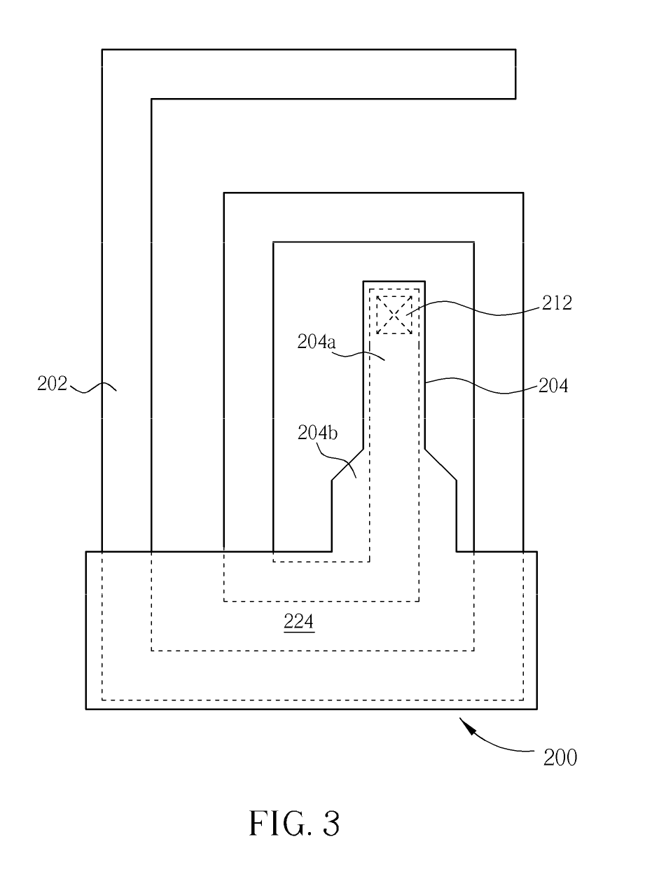

FIG. 3 demonstrates an electrical fuse structure 200 according to another embodiment of this invention. As shown in FIG. 3, the electrical fuse structure 200 comprises a first metal strip 202, a second metal strip 204, and a conductive via element 212 connecting the first metal strip 202 with the second metal strip 204. According to this embodiment, the first metal strip 202 is a spiral-shaped metal strip. Likewise, the first metal strip 202 may act as a cathode fuse link and may be fabricated in a lower level of the metal interconnection scheme, for example, M1. The second metal strip 204 may act as an anode fuse link and is fabricated in a higher level of the metal interconnection scheme, for example, M2. The second metal strip 204 may include a slender line-shaped portion 204a and a tapered portion 204b.

According to this embodiment, the tapered portion 204b connects the slender line-shaped portion 204a with the anode terminal pad 224. It is understood that the tapered portion 204b may be spared. One distal end of the first metal strip 202 is electrically coupled to one distal end of the second metal strip 204 by means of the via element 212. The first metal strip 202 may overlap with the anode terminal pad 224 when viewed from above. The overlapping part is indicated by dashed line.

Compared to FIG. 1, the electrical fuse structure 100 and the electrical fuse structure 200 may occupy substantially the same surface area or real estate in an integrated circuit chip, while the first metal strip 202 of the electrical fuse structure 200 has a much longer fuse link length. By providing such unique configuration, the electromigration effect is enhanced during the fuse blowing process. The yield and reliability during fuse blowing operation can be significantly improved. It is understood that the shapes of the first metal strip 202 and the second metal strip 204 are shown here for illustration purposes only. The first metal strip 202 may have other shapes such as serpentine, polygonal or irregular shapes in other embodiments without departing from the spirit of the present invention.

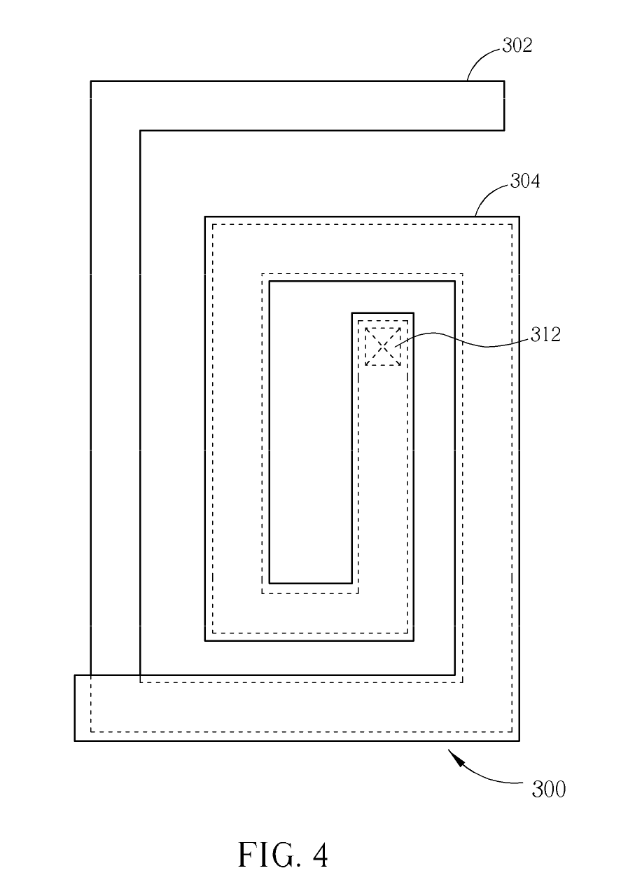

FIG. 4 demonstrates an electrical fuse structure 300 according to still another embodiment of this invention. One difference between the electrical fuse structure 300 of FIG. 4 and the electrical fuse structure 200 of FIG. 3 is that the electrical fuse structure 300 has a spiral-shaped second metal strip 304. The spiral-shaped second metal strip 304 does not include a tapered portion. One end of the first metal strip 304 and one end of the second metal strip 304 are electrically connected to each other by means of the via element 312. The overlapping part between the first metal strip 304 and the second metal strip 304 is indicated by dashed line.

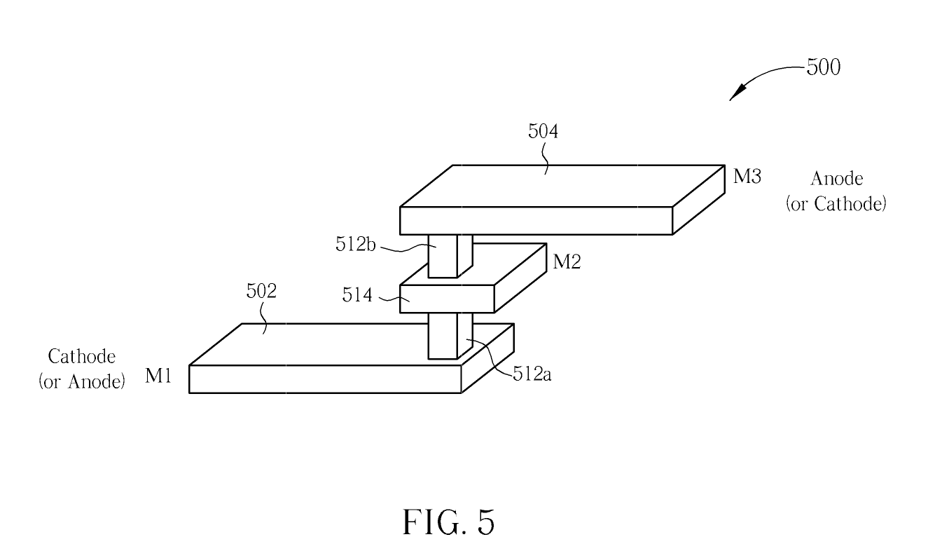

FIG. 5 is a perspective view of an electrical fuse structure 500 according to another embodiment of this invention. For the sake of clarity, the dielectric layers are omitted and only the skeleton of the electrical fuse structure 500 is illustrated. As shown in FIG. 5, the electrical fuse structure 500 comprises a first metal strip 502, a second metal strip 504, a first via element 512a, a second via element 512b and a connection pad 514 between the first via element 512a and the second via element 512b. The first metal strip 502 may act as a cathode fuse link and may be fabricated in a lower level of the metal interconnection scheme, for example, M1. The connection pad 514 may be fabricated in M2 and the second metal strip 504 may be fabricated in M3.

The first via element 512a is disposed between the first metal strip 502 and the connection pad 514 to electrically connect one end of the first metal strip 502 with the connection pad 514. The second via element 512b is disposed between the second metal strip 504 and the connection pad 514 to electrically connect one end of the second metal strip 504 with the connection pad 514.

Likewise, the first metal strip 502 has a line width W₁ and a length L₁, the second metal strip 504 has a line width W₂ and a length L₂, and the via elements 512a and 512b have a via width W₀. According to the embodiment of the invention, W₁<5W₀ is acceptable, preferably W₁<2W₀, and more preferably is that W₁ is substantially equal to W₀. According to the embodiment of the invention, W₂<5W₀, L₁/W₁>5, and L₂/W₂>5.

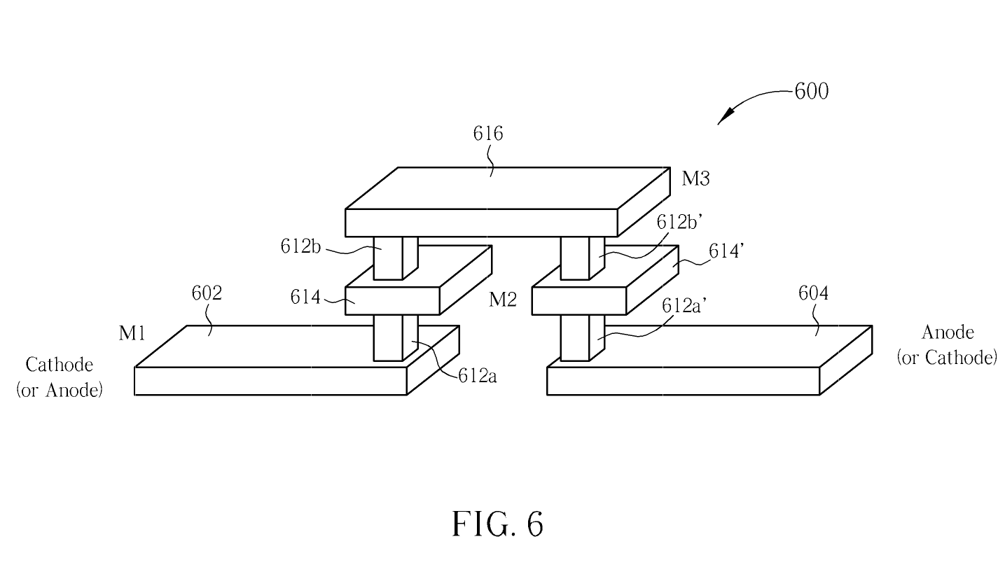

FIG. 6 is a perspective view of an electrical fuse structure 600 according to another embodiment of this invention. For the sake of clarity, the dielectric layers are omitted and only the skeleton of the electrical fuse structure 600 is illustrated. As shown in FIG. 6, the electrical fuse structure 600 comprises a first metal strip 602, a second metal strip 604, a first via element 612a, a second via element 612b, a third via element 612a′, a fourth via element 612b′, a first connection pad 614 between the first via element 612a and the second via element 612b, a second connection pad 614′ between the third via element 612a′ and the fourth via element 612b′, and a topmost connection metal line 616 electrically coupling the second via element 612b and the fourth via element 612b′. The first metal strip 602 and the second metal strip 604 may be both fabricated in a lower level of the metal interconnection scheme, for example, M1. The first connection pad 614 and the second connection pad 614′ may be fabricated in M2. The topmost connection metal line 616 may be fabricated in M3.

The first via element 612a is disposed between the first metal strip 602 and the first connection pad 614 to electrically connect one end of the first metal strip 602 with the first connection pad 614. The second via element 612b is disposed between the first connection pad 614 and the topmost connection metal line 616 to electrically connect one end of the topmost connection metal line 616 with the first connection pad 614. The third via element 612a′ is disposed between the second metal strip 604 and the second connection pad 614′ to electrically connect one end of the second metal strip 604 with the second connection pad 614′. The fourth via element 612b′ is disposed between the second connection pad 614′ and the topmost connection metal line 616 to electrically connect the other end of the topmost connection metal line 616 with the second connection pad 614.

Likewise, the first metal strip 602 has a line width W₁ and a length L₁, the second metal strip 604 has a line width W₂ and a length L₂, and the via elements 612a, 612b, 612a′ and 612b′ have a via width W₀. According to the embodiment of the invention, W₁<5W₀ is acceptable, preferably W₁<2W₀, and more preferably is that W₁ is substantially equal to W₀. According to the embodiment of the invention, W₂<5W₀, L₁/W₁>5, and L₂/W₂>5. The topmost connection metal line 616 has a line width Wₙ and a length Lₙ (n is an integer between 3 and 8). According to the embodiment of the invention, Wₙ<5W₀ is acceptable, preferably Wₙ<2W₀, and more preferably is that Wₙ is substantially equal to W₀. According to the embodiment of the invention, Lₙ/Wₙ>5.

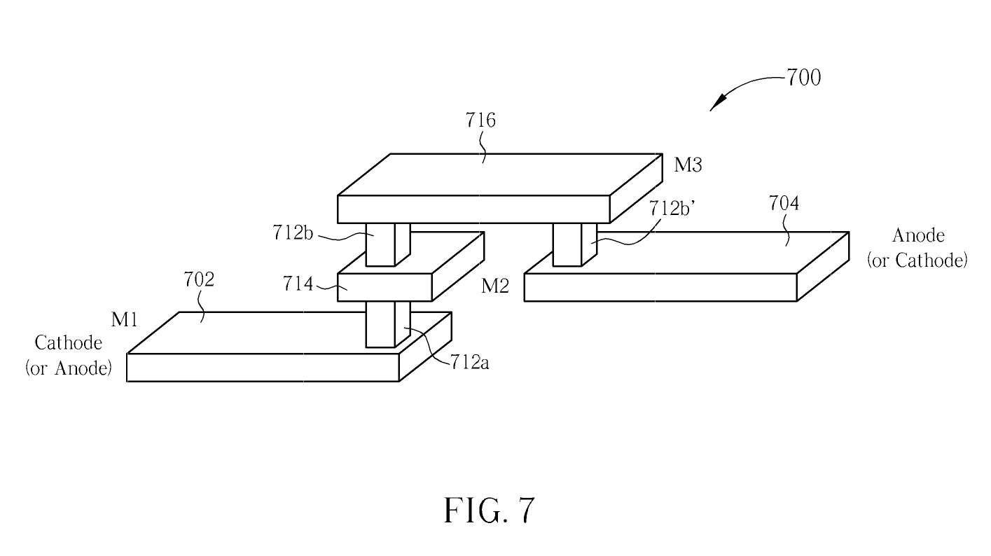

FIG. 7 is a perspective view of an electrical fuse structure 700 according to yet another embodiment of this invention. For the sake of clarity, the dielectric layers are omitted and only the skeleton of the electrical fuse structure 700 is illustrated. As shown in FIG. 7, the electrical fuse structure 700 comprises a first metal strip 702, a second metal strip 704, a first via element 712a, a second via element 712b, a third via element 712a′, a connection pad 714 between the first via element 712a and the second via element 712b, and a topmost connection metal line 716 electrically coupling the second via element 712b and the third via element 712b′. In this embodiment, the first metal strip 702 is fabricated in a lower level of the metal interconnection scheme, for example, M1, while the connection pad 714 and the second metal strip 704 are both fabricated in a higher level of the metal interconnection scheme, for example, M2. The topmost connection metal line 716 may be fabricated in M3.

The first via element 712a is disposed between one end of the first metal strip 702 and the connection pad 714 to electrically connect the distal end of the first metal strip 702 with the connection pad 714. The second via element 712b is disposed between the connection pad 714 and the topmost connection metal line 716 to electrically connect one distal end of the topmost connection metal line 716 with the connection pad 714. The third via element 712b′ is disposed between the second metal strip 704 and the topmost connection metal line 716 to electrically connect one distal end of the second metal strip 704 with the other end of the topmost connection metal line 716.

Likewise, the first metal strip 702 has a line width W₁ and a length L₁, the second metal strip 704 has a line width W₂ and a length L₂, and the via elements 612a, 612b, and 612b′ have a via width W₀. According to the embodiment of the invention, W₁<5W₀ is acceptable, preferably W₁<2W₀, and more preferably is that W₁ is substantially equal to W₀. According to the embodiment of the invention, W₂<5W₀, L₁/W₁>5, and L₂/W₂>5. The topmost connection metal line 716 has a line width Wₙ and a length Lₙ (n is an integer between 3 and 8). According to the embodiment of the invention, Wₙ<5W₀ is acceptable, preferably Wₙ<2W₀, and more preferably is that Wₙ is substantially equal to W₀. According to the embodiment of the invention, Lₙ/Wₙ>5.

Those skilled in the art will readily observe that numerous modifications and alterations of the device and method may be made while retaining the teachings of the invention.

What is claimed is:

1. An electrical fuse structure, comprising:
a first metal strip having a first width W₁ and a first length L₁;
a second metal strip having a second width W₂ and a second length L₂; and
at least one via element having a via width W₀, the via element being electrically connecting one end of the first metal strip to one end of the second metal strip, wherein W₁<5W₀.

2. The electrical fuse structure according to claim 1 wherein W₁<2W₀.

3. The electrical fuse structure according to claim 1 wherein W₁ is substantially equal to W₀.

4. The electrical fuse structure according to claim 1 wherein W₂<5W₀.

5. The electrical fuse structure according to claim 4 wherein W₂<2W₀.

6. The electrical fuse structure according to claim 4 wherein W₂ is substantially equal to W₀.

7. The electrical fuse structure according to claim 1 wherein the first metal strip is fabricated in a lower level of an interconnection scheme.

8. The electrical fuse structure according to claim 7 wherein the second metal strip is fabricated in a higher level of the interconnection scheme.

9. The electrical fuse structure according to claim 7 wherein the first metal strip and the second metal strip are in the same level of the interconnection scheme.

10. The electrical fuse structure according to claim 1 wherein the first metal strip is spiral-shaped.

11. An electrical fuse structure, comprising:
a first metal strip having a first width W₁ and a first length L₁;
a second metal strip having a second width W₂ and a second length L₂;
a connection pad between the first metal strip and the second metal strip;
a first via element electrically connecting one end of the first metal strip to the connection pad; and
a second via element electrically connecting one end of the second metal strip to the connection pad, wherein the first and second via elements have a via width W₀, and W₁<5W₀.

12. The electrical fuse structure according to claim 11 wherein W₁<2W₀.

13. The electrical fuse structure according to claim 11 wherein W₁ is substantially equal to W₀.

14. The electrical fuse structure according to claim 11 wherein W₂<5W₀.

15. The electrical fuse structure according to claim 14 wherein W₂<2W₀.

16. The electrical fuse structure according to claim 14 wherein W₂ is substantially equal to W₀.

17. The electrical fuse structure according to claim 1 wherein the first metal strip is fabricated in a lower level of an interconnection scheme.

18. The electrical fuse structure according to claim 17 wherein the second metal strip is fabricated in a higher level of the interconnection scheme.

19. The electrical fuse structure according to claim 17 wherein the first metal strip and the second metal strip are in the same level of the interconnection scheme.

20. The electrical fuse structure according to claim 11 wherein the first metal strip is spiral-shaped.
